(19) United States
(12) Patent Application Publication
(10) Pub. No.: US 2014/0259687 A1
(43) Pub. Date: Sep. 18, 2014

(54) KNIFE WITH ASSISTED OPENING MECHANISM

(71) Applicant: Bear & Son Cutlery, Inc., Jacksonville, AL (US)

(72) Inventor: Matthew E. GRIFFEY, Jacksonville, AL (US)

(73) Assignee: Bear & Son Cutlery, Inc., Jacksonville, AL (US)

(21) Appl. No.: 13/830,235

(22) Filed: Mar. 14, 2013

(51) Int. Cl. B26B 1/02

(52) U.S. Cl. CPC B26B 1/02
USPC 30/159

(57) ABSTRACT

A folding knife includes a handle, a pivot axle, a knife blade, a spring and a catch mechanism. The handle has an elongate opening and the pivot axle is adjacent one end of the handle. The knife blade has a tang at one end thereof that is pivotally mounted to the handle for pivotal movement about the pivot axle. The spring is at least partially fitted within the handle and fitted about the pivot axle for urging the knife blade from a closed position toward an open position. The catch mechanism releasably secured the knife blade at or near its closed position despite the urging of the spring.

### TECHNICAL FIELD

The present invention relates generally to tools and cutlery, and in particular to a folding knife and to mechanisms for assisting in urging the knife blade to both move to an open position or stay in a closed position.

### BACKGROUND

A folding knife has a housing or handle for supporting the blade in an open position and for receiving the blade in a closed position. Generally, known folding knives have a locking mechanism to cause the blade of the knife to be locked when in the open position. Commonly, folding knives require two hands to open, which can be known to be disadvantageous. For example, users commonly use folding knives when they are working on a project or need to cut something quickly, in which one hand is being occupied by the project or object to be cut. To assist the user in opening the folding knife with one hand, an opening mechanism can be provided within the knife. Various opening mechanisms are known, but continued improvements are sought. It is to the provision of an improved folding knife that the present invention is primarily directed.

### SUMMARY

Generally described, the present invention relates to a folding knife. In a first example embodiment, the present invention relates to a folding knife including a handle, a pivot axle, a knife blade, a spring, and a catch. The handle includes an elongate opening and the pivot axle is adjacent one end of the handle. The knife blade includes a tang at one end thereof, and the tang is pivotally mounted to the handle for pivotal movement about the pivot axle. The spring is at least partially positioned within a portion of the handle and fitted about the pivot axle for urging the knife blade from a closed position toward an opened position. The catch releasably secures the knife blade at or near its closed position despite the urging of the spring.

The catch includes a spring-biased lever in the handle and a cam surface formed on the tang of the knife blade for engaging the lever.

Optionally, the folding knife can include a limit pin for limiting movement of the spring-biased lever toward the tang beyond a certain extent to prevent the lever from frictionally engaging the tang as the knife blade moves toward its fully open position.

Generally, the knife blade is held at or near its closed position until a user of the folding knife manually moves the knife blade to a certain point toward the knife blade's open position, at which point the spring takes over and moves the knife blade the rest of the way to the open position. In one form, the spring comprises a helical torsion spring.

In a second example embodiment, the present invention relates to a folding knife including a handle having an elongate opening, a pivot axle adjacent one end of the handle, a knife blade, and a spring. The knife blade includes a tang at one end thereof and the tang is pivotally mounted to the handle for pivotal movement about the pivot axle, and wherein the knife blade can be at least partially received in the elongate opening of the handle. The spring is at least partially positioned within a portion of the handle and fitted about the pivot axle for urging the knife blade from a closed position toward an opened position.

Optionally, the folding knife can further include a catch for releasably securing the knife blade at or near its closed position despite the urging of the spring. the catch includes a spring-biased lever in the handle and a cam surface formed on the tang of the knife blade for engaging the lever. Additionally, the folding knife can further include a limit pin for limiting movement of the spring-biased lever toward the tang beyond a certain extent to prevent the lever from frictionally engaging the tang as the knife blade moves toward its fully open position.

Generally, the knife blade is held at or near its closed position until a user of the folding knife manually moves the knife blade to a certain point toward the knife blade's open position, at which point the spring takes over and moves the knife blade the rest of the way to the open position. The spring can comprise a helical coil spring.

In a third example embodiment, the present invention relates to a folding knife including a handle having an elongate opening, a pivot axle adjacent one end of the handle, a knife blade, a helical torsion spring, and a catch. The folding knife includes a tang at one end thereof and the tang is pivotally mounted to the handle for pivotal movement about the pivot axle, and the knife blade can be at least partially received in the elongate opening of the handle. The helical torsion spring is at least partially positioned within a portion of the handle and is fitted about the pivot axle for urging the knife blade from a closed position toward an opened position. The catch releasably secures the knife blade at or near its closed position despite the urging of the spring, and the knife blade is held at or near its closed position until a user of the folding knife manually moves the knife blade to a certain point toward the knife blade's open position, at which point the spring takes over and moves the knife blade the rest of the way to the open position.

Generally, the catch includes a spring-biased lever in the handle and a cam surface formed on the tang of the knife blade for engaging the lever.

Optionally, the folding knife can include a limit pin for limiting movement of the spring-biased lever toward the tang beyond a certain extent to prevent the lever from frictionally engaging the tang as the knife blade moves toward its fully open position.

The specific techniques and structures employed to improve over the drawbacks of the prior devices and accomplish the advantages described herein will become apparent from the following detailed description of example embodiments and the appended drawings and claims.

### BRIEF DESCRIPTION OF THE DRAWINGS

FIG. 1 is a side view of a folding knife according to a first example embodiment of the present invention, showing the knife blade in a closed position.

FIG. 2 is a side view of the folding knife of FIG. 1, showing the knife blade in an open position.

FIG. 3 is a side view of the folding knife of FIG. 1, wherein portions are removed to show internal portions thereof.

FIG. 4 is a side view of the folding knife of FIG. 2, wherein portions are removed to show internal portions thereof.

FIG. 5 is a bottom left-side perspective exploded view of the folding knife of FIG. 1.

FIG. 6 is a top left-side perspective exploded view of the folding knife of FIG. 1.

FIG. 7 is a top right-side perspective exploded view of the folding knife of FIG. 1.

FIG. 8 is a top view of the knife of FIG. 1.

FIG. 9 is a top view of a portion of the knife of FIG. 1 showing the knife blade in an open position.

FIG. 10 is a detailed top view of a portion of the knife of FIG. 9.

FIG. 11 is a side view of the knife blade of FIG. 2.

FIG. 12 is a side view of the lever of FIG. 5.

FIG. 13 is a side view of the pivot pin portion of the knife of FIG. 1.

FIG. 14 is a perspective view of the biasing spring portion of the knife of FIG. 5.

FIGS. 15-20 are side views of the sequential operation of the blade pivoting from a closed position to an open position, showing the catch mechanism wherein the cam surface of the tang and the engagement feature of the lever provide for both engagement and disengagement therebetween.

### DETAILED DESCRIPTION OF EXAMPLE EMBODIMENTS

Generally described, the present invention relates to a folding knife wherein mechanisms for assisting in urging the blade to both move to an open position when opening the knife from a closed position or stay in a closed position when the knife is closed. The folding knife generally comprises a handle having an elongate opening, a pivot axle adjacent one end of the handle, a knife blade having a tang at one end thereof, a spring, and a catch mechanism. The tang of the knife blade is pivotally mounted to the handle for pivotal movement about the pivot axle wherein the knife blade can at least be partially received in the elongate opening of the handle. The spring is at least partially positioned within a portion of the handle and fitted about the pivot axle for urging the knife blade from a closed position to an open position. The catch mechanism comprises a spring-biased lever in the handle and a cam surface formed on the tang of the knife blade for engaging the lever. Thus, the catch mechanism releasably secures the knife blade at or near its closed position despite the urging of the spring.

FIGS. 1-10 show a folding knife 10 according to a first example embodiment of the present invention. In general, the folding knife 10 includes a handle 12, a knife blade 30, a pivot pin 60, a spring 66, and a catch mechanism comprising a cam surface 52 and a lever 82.

The handle 12 includes first and second side parts 14a, 14b that each include a rounded or curved front end 16 and a tapered rear end 20. Each of the side parts 14a, 14b has an inner lining or surface 22a, 22b. The inner linings 22a, 22b are connected to a catch bit 74 near the tapered rear end 20 and a lever 82 at side of the handle 12 between the rounded front end 16 and the tapered rear end 20. Thus, the catch bit 74 and the lever 82 are sandwiched between the inner linings 22a, 22b to define an elongate channel 24 within the handle 12 wherein the knife blade 30 can at least be partially received. The pivot pin 60 comprising a pivot axle 62 is provided near the rounded front end 16.

The knife blade 30 comprises a distal end 32 and a proximal end 34, with a tang 40 adjacent the proximal end 34. The tang 40 is pivotally mounted between the spaced apart inner linings 22a, 22b to the pivot axle 62. The spring or biasing member 66 generally comprises a helical torsion spring comprising a first end 70 and a second end 72 (see FIG. 14). The biasing member 66 is at least partially positioned within a portion of the handle 12, for example a pocket 26 (see FIGS. 5-6) of the side part 14b of the housing 12. The pocket 20 is formed within the inner lining 22b. The biasing member 66 is fitted about the pivot axle 62 of the pivot pin 60 to provide for urging the knife blade from a closed position (see FIGS. 1, 3, 8) to an open position (see FIGS. 2, 4, 9, 10).

Preferably, an elongate slot or channel 27 (see FIGS. 3, 4) communicates with the pocket 20 for receiving and retaining the first end 70 of the biasing member 66. As is commonly well known in the art, a liner lock 78 is provided for locking the knife blade 30 in the open position. The liner lock 78 has a leaf spring-like free end portion that is fitted within a recess or pocket formed along the inner lining 22b of the side part 14b. The free end portion communicates with the tang 40 of the blade 30 when the blade 30 is in the open position so as to prevent folding of the blade into the central cavity 24 due to the free end portion being in the path of travel of a front locking stop 50 of the tang 40, preventing pivoting of the blade 30 (see FIGS. 4, 10). To allow the blade 30 to pivot to the closed position, the free end portion of the liner lock 78 is moved back within the recess of the inner lining 22b, freeing the path of travel of the tang 40.

FIG. 11 shows the knife blade 30 prior to the assembly of the knife. The tang 40 has a pivot 42 for pivotally mounting to the pivot axle 62 of the pivot pin 60. A plurality of engagement openings 44 generally surround the pivot 42 to provide for engagement with the second end 72 of the biasing member 66. Thus, with the pivot 42 engaging the pivot axle 62, and the biasing member 66 fitted about the pivot axle 62 (having first end 70 engaged with the channel 27 and the second end engaged with one of the openings 44), the knife blade is biased towards the open position. A lever stop 46 is formed near an upper portion of the tang 40 to engage a portion of the lever 82 when the blade 30 is in the open position. A portion of the catch mechanism having the cam surface 52 is formed near a lower portion of the tang 40. The cam surface 52 generally includes a nub 54 and a recess 56. Preferably, as will be described below, a portion of the lever movably engages the cam surface 52 to provide for releasably securing the knife blade 30 at or near its closed position despite the urging of the biasing member 66. Optionally, a thumb bob 120 is mounted on a side of the blade 30 near the proximal end 34.

FIG. 12 shows the lever 82. Preferably, the lever 82 is pivotally mounted between the inner linings 22a, 22b to pivot about a pivot axle 91. As depicted, the lever comprises a proximal end 84 and a distal 86 wherein a pivot 90 is generally formed therebetween. Preferably, the catch bit 74 that is mounted between the inner linings 22a, 22b near the tapered rear end 20 is provided with a spring wire 76. The spring wire 76 secures within a channel of the catch bit 74 and extends therefrom to engage a surface 87 near the distal end 86 of the lever 82. As such, the spring wire 76 biases the proximal end 84 of the lever 82 towards the cam surface 52 of the tang 40.

The proximal end 84 of the lever 82 comprises an engagement feature 92 for movably engaging the cam surface 52 of the tang 40. The engagement feature 92 generally has a finger-like hook 93, a recess 94, an upper surface 96 and a stop 98. The hook 93 preferably frictionally engages the cam surface 52 of the tang 40 when the blade 30 is at or near its closed position, thereby releasably securing the knife blade at or near its closed position despite the urging of the biasing member 66. A limit pin 100 extending between the side parts 14a, 14b (near the rounded front end 16) and positioned adjacent the recess 94 provides for engagement with the upper surface 96 of the engagement feature 92. Preferably, the limit pin 100 limits the movement of the engagement feature 92 towards the cam feature 52 (or tang 40) beyond a certain extent to prevent the lever from frictionally engaging the tang 40 as the knife blade moves toward its fully open position. The stop 98 is provided for contacting the lever stop 46 when the knife blade 30 is in the open position.

FIG. 13 shows the pivot pin 60 in greater detail. The pivot pin 60 generally comprises the pivot axle 62 and an internal engagement orifice 64. Preferably, the internal engagement orifice 64 is provided to accommodate receiving a fastener therein to provide for securing the pivot pin 60 to the side parts 14a, 14b of the housing. The internal engagement orifice 64 can comprise threads or other interengagement features for cooperative engagement with the fastener. As such, the pivot axle 62 extends the entire width between the inner linings 22a, 22b of the side parts 14a, 14b.

FIG. 14 shows the biasing member 66. In one form the biasing member 66 is a helical torsion spring. As depicted, the biasing member 66 defines a longitudinal axis A. In one form, the first arm 70 extends in a direction generally transverse the longitudinal axis A and the second arm 72 extends in a direction generally parallel and axially offset from the longitudinal axis A. Optionally, the first and second arms can extend in other directions relative to the longitudinal axis A as desired.

FIGS. 15-20 show the sequential operation of the catch mechanism as the blade moves from a closed position to an open position wherein portions of the folding knife 10 have been removed to show and isolate the interaction of the cam feature 52 and the lever 82 of the catch mechanism. FIG. 15 shows the knife in a closed position. The knife is grasped with the tapered rear end 20 of the handle 12 oriented towards the user's wrist and wherein the handle 12 rests in the palm that results in placement of the thumb bob 120 in close proximity to the user's thumb. As depicted, the hook 93 of the lever is frictionally engaged with the recess 56 of the cam surface 52 and overcomes the urging of the biasing member 66 such that the blade is held at the closed position. As pressure is applied to the thumb bob 120 upwards in the direction away from the palm, the hook 93 remains frictionally engaged with the cam surface 52. As shown in FIG. 16, pivotal movement of the blade 30 towards the open position (clockwise direction) causes the hook 93 to move along the cam surface 52 and engage the nub 54, which causes the proximal end 84 of the lever 82 to move upwards (see direction arrow) against the bias of the spring wire 76. As such, the frictional engagement between the hook 93 and the cam surface 52 continue to overcome the urging of the biasing member 66, which causes the blade 30 to remain near the closed position.

As the user continues to apply pressure to the thumb bob 120 upwards in the direction away from the palm (continuing to pivot the place in the clockwise direction), the hook 93 is removed from engagement with the nub 54 of the cam surface 52. As shown in FIG. 17, the hook 93 is removed from engagement with the nub 54 and the limit pin 100 halts any further movement of the engagement feature 92 towards the tang 40. At this point, the biasing member 66 takes over and moves the knife blade the rest of the way to the open position (see FIGS. 18-20). In the open position, the lever stop 46 of the tang 40 contacts the stop 98 of the lever 82 and the free end of the liner lock extends within the path of travel of the front locking stop 50 of the tang 40, preventing further pivoting of the blade 30 (see FIGS. 4, 10).

To close the blade 30, the user's thumb applies pressure to the free end of the liner lock 78, causing the same to move within the recess of the internal liner 22b (removing the same from the path of travel of the tang 40), and the blade is pivoted in a counter-clockwise direction to the closed position (see FIGS. 3, 15).

It is to be understood that this invention is not limited to the specific devices, methods, conditions, or parameters of the example embodiments described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the claimed invention has been shown and described in example forms, it will be apparent to those skilled in the art that many modifications, additions, and deletions can be made therein without departing from the spirit and scope of the invention as defined by the following claims.

What is claimed is:

1. A folding knife comprising:
a handle having an elongate opening;
a pivot axle adjacent one end of the handle;
a knife blade having a tang at one end thereof and wherein the tang is pivotally mounted to the handle for pivotal movement about the pivot axle, and wherein the knife blade can be at least partially received in the elongate opening of the handle;
a spring at least partially positioned within a portion of the handle and fitted about the pivot axle for urging the knife blade from a closed position toward an opened position; and
a catch for releasably securing the knife blade at or near its closed position despite the urging of the spring.

2. A folding knife as claimed in claim 1, wherein the spring comprises a helical torsion spring.

3. A folding knife as claimed in claim 1, wherein the catch includes a spring-biased lever in the handle and a cam surface formed on the tang of the knife blade for engaging the lever.

4. A folding knife as claimed in claim 3, further comprising a limit pin for limiting movement of the spring-biased lever toward the tang beyond a certain extent to prevent the lever from frictionally engaging the tang as the knife blade moves toward its fully open position.

5. A folding knife as claimed in claim 1, wherein the knife blade is held at or near its closed position until a user of the folding knife manually moves the knife blade to a certain point toward the knife blade's open position, at which point the spring takes over and moves the knife blade the rest of the way to the open position.

6. A folding knife comprising:
a handle having an elongate opening;
a pivot axle adjacent one end of the handle;
a knife blade having a tang at one end thereof and wherein the tang is pivotally mounted to the handle for pivotal movement about the pivot axle, and wherein the knife blade can be at least partially received in the elongate opening of the handle; and
a spring at least partially positioned within a portion of the handle and fitted about the pivot axle for urging the knife blade from a closed position toward an opened position.

7. A folding knife as claimed in claim 6, further comprising a catch for releasably securing the knife blade at or near its closed position despite the urging of the spring.

8. A folding knife as claimed in claim 7, wherein the catch includes a spring-biased lever in the handle and a cam surface formed on the tang of the knife blade for engaging the lever.

9. A folding knife as claimed in claim 8, further comprising a limit pin for limiting movement of the spring-biased lever toward the tang beyond a certain extent to prevent the lever from frictionally engaging the tang as the knife blade moves toward its fully open position.

10. A folding knife as claimed in claim 6, wherein the knife blade is held at or near its closed position until a user of the folding knife manually moves the knife blade to a certain point toward the knife blade's open position, at which point the spring takes over and moves the knife blade the rest of the way to the open position.

11. A folding knife as claimed in claim 6, wherein the spring comprises a helical torsion spring.

12. A folding knife comprising:
a handle having an elongate opening;
a pivot axle adjacent one end of the handle;
a knife blade having a tang at one end thereof and wherein the tang is pivotally mounted to the handle for pivotal movement about the pivot axle, and wherein the knife blade can be at least partially received in the elongate opening of the handle;
a helical torsion spring at least partially positioned within a portion of the handle and fitted about the pivot axle for urging the knife blade from a closed position toward an opened position; and
a catch for releasably securing the knife blade at or near its closed position despite the urging of the spring, and wherein the knife blade is held at or near its closed position until a user of the folding knife manually moves the knife blade to a certain point toward the knife blade's open position, at which point the spring takes over and moves the knife blade the rest of the way to the open position.

13. A folding knife as claimed in claim 12, wherein the catch includes a spring-biased lever in the handle and a cam surface formed on the tang of the knife blade for engaging the lever.

14. A folding knife as claimed in claim 13, further comprising a limit pin for limiting movement of the spring-biased lever toward the tang beyond a certain extent to prevent the lever from frictionally engaging the tang as the knife blade moves toward its fully open position.
